(19) United States
(12) Patent Application Publication
(10) Pub. No.: US 2022/0130001 A1
(43) Pub. Date: Apr. 28, 2022

(54) MACHINE LEARNED VACANCY METRIC IN A PROPERTY SYSTEM

(71) Applicants: George Yang, Corona, CA (US); William Wu, San Francisco, CA (US); Ryan Waliany, Bellevue, WA (US); Jennifer Bronzo, Sausalito, CA (US)

(72) Inventors: George Yang, Corona, CA (US); William Wu, San Francisco, CA (US); Ryan Waliany, Bellevue, WA (US); Jennifer Bronzo, Sausalito, CA (US)

(73) Assignee: Doorstead Inc, San Francisco, CA (US)

(21) Appl. No.: 17/077,328

(22) Filed: Oct. 22, 2020

(51) Int. Cl. G06Q 50/16; G06N 20/00; G06N 5/04; G06Q 30/02; G06Q 30/06

(52) U.S. Cl. CPC G06Q 50/16; G06N 20/00; G06N 5/04; G06F 3/14; G06Q 30/0645; G06Q 30/0278; G06Q 30/0206; G06Q 30/0205

(57) ABSTRACT

Method, systems, and apparatus for identifying a plurality of properties based at least on a location; determining, for each of the plurality of properties using a machine-learned model, a vacancy metric representing a duration the respective property will be available for rent, wherein the machine-learning model is trained using availability data for the plurality of properties; sending, for display to a user, a user interface comprising the vacancy metric.

### TECHNICAL FIELD

This disclosure relates to a property system that enables users to rent or purchase property.

### BACKGROUND

In a conventional rental property business, a landlord can choose to rent a property out using an agent. The agent chooses a price for a property based on historical prices for the property. Before a renter agrees to the price, the property is vacant, which leads to lost income to the landlord. Once a renter agrees to the price, the agent manages the property for the landlord for a percentage of the rental price.

### SUMMARY

Traditional property management services employ agents to assist homeowners with renting out their property. They determine a price for the property, advertise the property, handle tenant inquiries, screen applications, draw up lease agreements, and collect rent for the property. Typically, agents determine the price for the property by setting a human-determined price, determining an interest level based on the number of applications received, and potentially adjusting the price over a period of weeks until the property is rented out. When the property is not rented out, homeowners are not making rental income.

A property system described herein obtains property data from multiple internal and external property data sources to train a machine-learned classifier. The classifier can infer, for a particular property, a market price, a time to rent, or a risk level for a particular property based on data on the property. User interactions with the property system and with the internal and external data sources further train the system to identify appropriate market prices for properties in the property system.

The property system can also have a classifier that infers, for a particular property, a vacancy metric representing a duration the property will be available for rent. This vacancy metric can be placed, e.g., via a user interface, into an offer for the homeowner that guarantees payment by the property system within a certain amount of time. The vacancy metric can also be used to adjust the market price or the risk level for the property.

In one aspect, a method for identifying a plurality of properties based at least on a location; determining, for each of the plurality of properties using a machine-learned model, a vacancy metric representing a duration the respective property will be available for rent, wherein the machine-learning model is trained using availability data for the plurality of properties; sending, for display to a user, a user interface comprising the vacancy metric. Identifying the plurality of properties is further based on one or more of the following: property data comprising a number of bedrooms, a number of bathrooms, or a size, pricing data, or a timeframe. Receiving a request from a user to generate a vacancy metric for a particular property, wherein the request comprises the location; in response to receiving the request, determining the vacancy metric is in response to receiving the request, and wherein identifying the plurality of properties is based at least on property data for the property. Determining a price adjustment for price of the property based on the vacancy metric. Training the machine-learning model further comprises, for a given property: identifying public digital listings for the property or properties similar to the property; tracking the public digital listings, wherein the tracking comprises storing changes in pricing for the public digital listings and availability durations of the public digital listings; determining one or more public digital listings are no longer available; and training the machine-learning model to determine the vacancy metric for the property based on determining one or more public digital listings are no longer available. Determining a confidence score of the machine-learning model; and adjusting the vacancy metric with a particular frequency based on the confidence score.

Advantages may include one or more of the following. The property system described herein can automatically determine a market price for a homeowner's property. For example, the property system monitors rental activity for similar properties in real-time using internal and external databases. As a result, the property system can adjust the price more quickly than traditional systems that do not consider data. Adjusting prices quickly causes the property to be rented out more quickly at market price due to having continuously updated and accurate market prices for sales and rentals. This allows the homeowner to collect more rental income since they are placed more quickly.

The property system can automatically determine a vacancy metric for the homeowner's property. The vacancy metric gives the homeowner a guarantee as to when he or she can first expect payment when utilizing the property system as a customer, and the vacancy metric lowers the risk for the property system paying the guarantee without recouping the guarantee from a renter because the vacancy metric is based on similar comparisons.

### BRIEF DESCRIPTION OF THE DRAWINGS

FIG. 1 is a schematic illustration of an example property system architecture.

FIG. 2 is a flow chart of an example process of adjusting prices for properties.

FIG. 3 is a flow chart of an example process of adjusting prices for properties based on tracking public listings.

FIG. 4 is an illustration of an example user interface of a digital listing of a property.

FIGS. 5A-B are illustrations of example user interfaces to schedule visits to rent or purchase a property and to chat with owners of properties using the property system.

FIG. 6 is a flow chart of an example process of determining vacancy metrics for properties.

FIG. 7 is a flow chart of an example process of determining vacancy metrics based on tracking public listings.

FIG. 8 is an illustration of an example user interface of a digital listing of a property with a vacancy metric.

Like reference numbers and designations in the various drawings indicate like elements.

### DETAILED DESCRIPTION

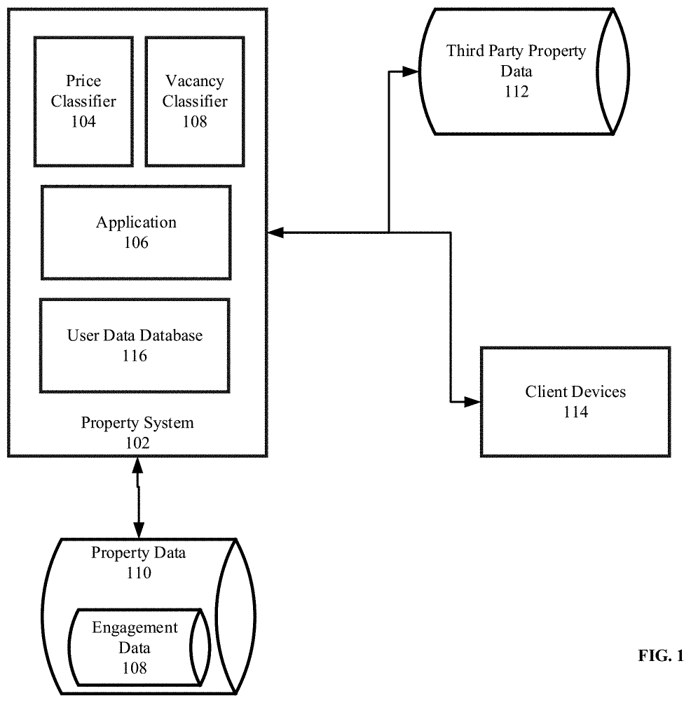

FIG. 1 is a schematic illustration of an example property system architecture. The property system architecture includes a property system 102 that interfaces with third party property data 112 and client devices 114, e.g., over the Internet. Client devices can be mobile device, desktop, or laptop computers. In some implementations, the property system 102 is a software-as-a-service (SaaS) based property management platform.

Various third parties can collect third party property data 112 and provide the third party property data 112 for access by the property system 102. In some implementations, the third party property data 112 includes property information including an address, historical purchase price information, historical rental price information, attributes of the property, e.g., a number of bedrooms and bathrooms, a number of square feet, a price per square foot, a year of construction, an estimated cost of home ownership, an estimated cost of renting, prices of properties in nearby areas, or prices of similarly sized properties. In some implementations, the third party property data 112 also includes information on property type, e.g., condo, townhouse, or single family home, a homeowner association cost, parking availability, heating and cooling availability, gym, doormen, or laundry availability, statistics on neighborhood safety, statistics on access to freeways, food, and shopping, written description of the property, or description of nearby schools. In some implementations, the third party property data 112 includes user interaction data for a particular property, e.g., a number of views for a particular listing, a creation date for the listing, a number of times users have messaged a property manager associated with the listing, and a number of times users have saved or indicated interest in the property.

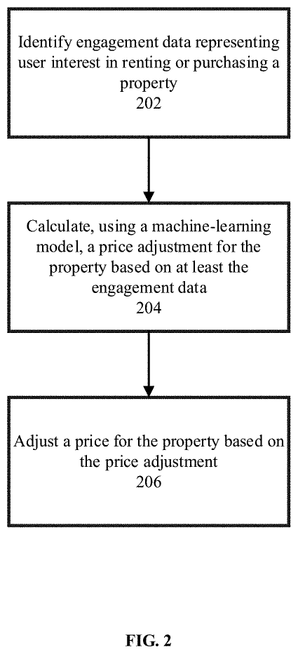

The property system 102 includes a price classifier 104 and an application 106. The price classifier 104 can process input from the third party property data 112 and property data 110, described below, to identify price adjustments for particular properties. The price classifier 104 will be described further below in reference to FIG. 2. After the price classifier 104 aids in determining market prices, the prices for particular properties can be displayed by the application 106, which serves a user interface to the client devices 114.

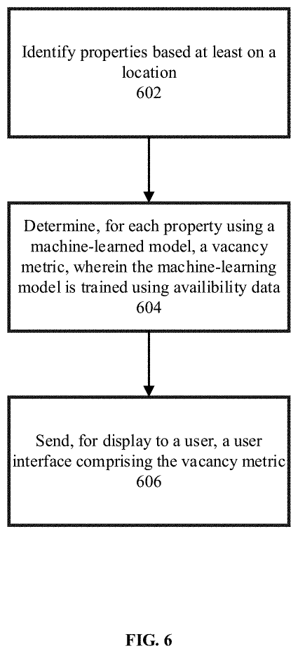

The property system 102 also includes a vacancy classifier 108. The vacancy classifier 108 can process input from the third party property data 112 and property data 110 to identify a vacancy metric for particular properties. The vacancy classifier 108 will be described further below in reference to FIG. 6.

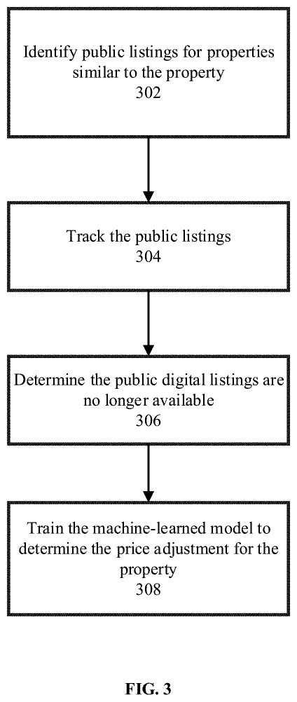

In some implementations, the property system 102 parses the third party property data 112 and generates engagement data 108 as a structured format of the third party property data 112. This will be described further below in FIG. 3. In some other implementations, engagement data 108 includes user interactions with the application 106.

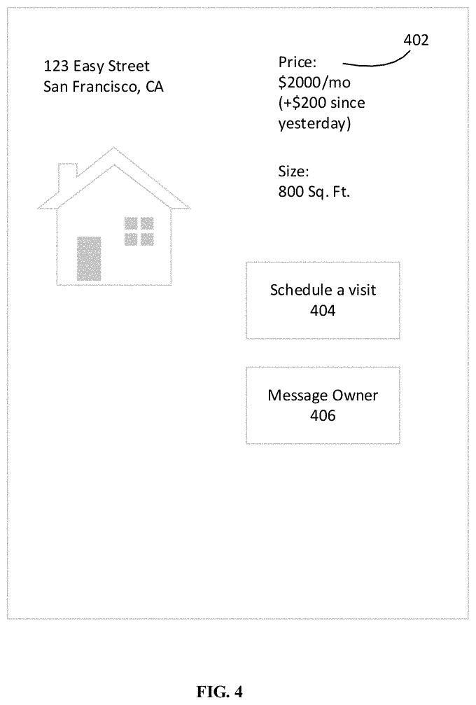

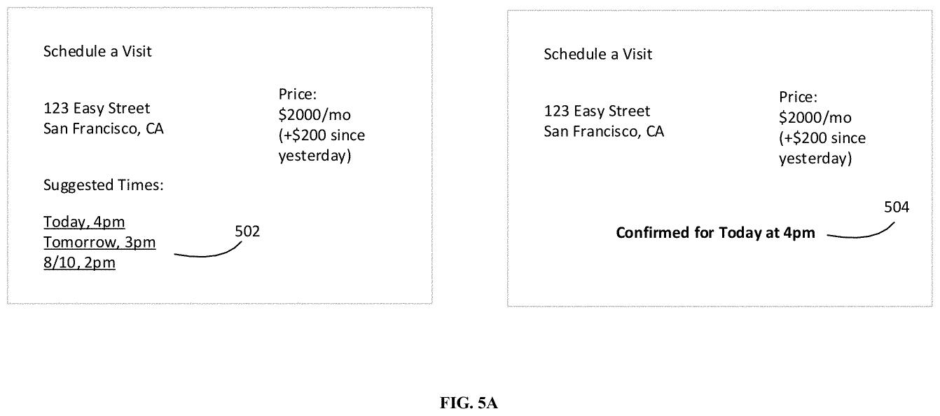

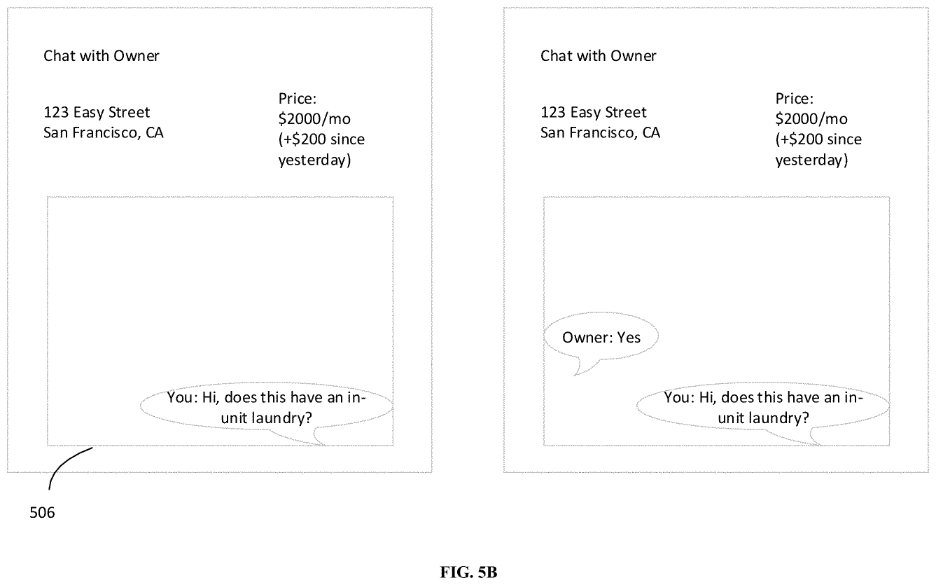

The property data 110 includes engagement data 108, which can include a user's indication of interest throughout the property renting or purchasing process. Example implementations of collection of the property data 110 and the property renting or purchasing user flows will be described further below in FIGS. 4, 5A, and 5B. The engagement data 108 can include data from internal, e.g., user interaction with the application 106, and external databases, e.g., the third party property data 112. In some further implementations, the engagement data 108 tracks interest of users in renting or purchasing properties having a particular profile, e.g., a location, size, or price of a property. For example, the engagement data 108 can include tracking a number of users interacting with properties in a particular zip code, within a particular price range, or properties of a similar size.

The property system 102 can, through the application 106, provide for display properties for purposes of purchase or rental. For rental properties, the property system can provide a user interface for would-be tenants to enter personal identifying information, e.g., a name, credit score, or social security number. The user interface allows the would-be tenants to communicate with property owners, e.g., to ask questions, establish appointments to visit the property, and sign leases with the property owners.

While users engage with the property system to sign leases for properties, the property system constantly adjusts prices for the properties. By adjusting prices frequently, the property system can more quickly identify a price at which a buyer and seller will sign a lease. In some implementations, the property system displays real-time updating prices throughout the entire rental or purchase user flow.

The property system 102 also includes a user data database 116. Users of the property system 102 can provide payment information, e.g., a bank account, into which the property system 102 can deposit money from renters. Payment transactions can be handled by the property system 102 to allow properties owned by users to be managed by the property system 102.

FIG. 2 is a flow chart of an example process of adjusting prices for properties performed by a property system, e.g., using a price classifier 104 of the property system 102 referenced in FIG. 1.

The property system identifies engagement data representing user interest in renting or purchasing a property (step 202). The engagement data can include impression data, tenant application data, messaging data, appointment data, or rental data. The property system can identify the engagement data from third party sources or from internal sources. In some implementations, the engagement data is aggregated while the listing is available for public access on the Internet. Rental data will be described further below in reference to FIG. 3.

In some implementations, impression data includes a number of times users have viewed a listing advertising the property, a number of times users have interacted with buttons and links on the listing, or an amount of user time spent viewing the listing. In some further implementations, the tenant application data includes the amount of information provided by a would-be tenant, e.g., gender, age, location of the tenant, or previous rental history of the tenant. The messaging data can include the number of times a user sends a message through the property system or sends a message to owners of properties having similar profiles. The appointment data can include the number of times a user makes an appointment through the system or the number of times a user makes an appointment for a particular property or similar properties. The engagement data can further include the amount of times a user has viewed listings similar to a particular property profile, or previous rental history of the user.

To generate property profiles that interest a user, the property system can represent properties as embeddings, e.g., vector embeddings. By grouping the embeddings representing similar properties interacted with by the user, the property system can identify properties that the user has interacted with and generate a property profile, e.g., data representation of similar properties. The property system can calculate a similarity score between any subsequent properties interacted with by the user and the property profile using the embeddings.

The property system calculates, using a machine-learning model, a price adjustment for the property based on at least the engagement data (step 204). In some implementations, the price adjustment is a value indicating an increase or decrease in price of the property compared to a previously stored price. For example, the value can be +$100/month. In some other implementations, the price adjustment is a final price. For example, the final price can be $2900/month. In some other implementations, the price adjustment is a state of one of the following: overpriced, e.g., the price should be decreased, underpriced, e.g., the price should be increased, or accurately priced, e.g., the price should remain the same. The machine-learning model can output confidence values associated with each state. Furthermore, in some implementations, the property system calculates the price adjustment based on the property data described in reference to FIG. 1, e.g., a size or location of the property.

The property system adjusts a price for the property based on the price adjustment (step 206). If the price adjustment is a value, the property system can update the price for the property based on the value, e.g., by adding or subtracting the value to the previous price. By way of illustration, if the value outputted by the property system was $100/month and the previous price was $2800/month, the property system can determine the price for the property to be $2900/month. If the price adjustment is a final price, the property system can provide the final price for display to client devices. If the price adjustment is a state, the property system can update the price based on the state by an incremental amount, e.g., a fixed number or a fixed percentage of the previous price. Client devices accessing the property system can then have immediate access to the updated price.

The machine-learning model can be trained using supervised learning algorithms, e.g., linear or logistic regressions, Kalman filters. The machine-learning model can take, as training data, engagement data for properties in particular time periods and rental data, e.g., prices at which the properties were rented out. The data can be labelled according to the output of the classifier. Further examples of training data will be described below in reference to FIG. 3.

FIG. 3 is a flow chart of an example process of adjusting prices for properties based on tracking public listings. In some implementations, tracking public listings creates training data for the machine-learning model described above in reference to FIG. 2.

In particular, to price a particular property, a property system can identify public digital listings for the property or properties similar to the particular property (step 302). Public digital listings can be created by a seller or landlord of a property for advertisement. The property system can access these listings from an internal or external database, e.g., through the Internet. For example, the property system can employ a web spider that crawls listings that have been publicly posted by other property systems. The property system can determine similarity between properties using embeddings, as described above, or by measuring distance between parameters of the properties, e.g., size, number of bedrooms, or number of bathrooms of the properties.

The property system can track the public digital listings (step 304). In some implementations, the property system tracks when any given public digital listing was created, changes in posted prices for the property, and how long the public digital listing was available for public viewing. The property system can process all metadata displayed on the public digital listing, e.g., size of the property, number of views for the page. In some implementations, the property system recrawls public digital listings on a periodic basis, e.g., every hour. The property system can track changes to public digital listings in an internal database.

The property system can determine the public digital listings are no longer available (step 306). For example, the property system can periodically request a resource for the public listing. If the public listing resource is no longer being served, the property system can determine the public digital listing is no longer available.

In some implementations, the property system infers a market price of sale or rent based on the tracked price when the public digital listing was most recently available. The property system can determine an availability duration based on the creation date of the public digital listing and the date the public digital listing is no longer available.

In some implementations, the property system infers states of overpriced, e.g., the price should be decreased, underpriced, e.g., the price should be increased, or accurately priced, e.g., the price should remain the same, from the availability duration. For example, if the availability duration is under a threshold duration, e.g., 14 days or 1 month, the property system can infer the property price should be increased. If the availability duration is over a threshold duration, the property system can infer the property price should be decreased. If the availability duration equals the threshold duration, the property system can infer the property price should remain the same.

The property system can aggregate data representing the availability duration, inferred sale, rental prices, or states that are associated with public digital listings and treat the aggregated data as training data for the machine-learned model. The property system can train the machine-learned model to determine price adjustments for the property (step 308). In some implementations, to determine the price adjustment, the property system provides, as input to the newly trained machine-learned model, engagement data as described above in reference to FIG. 1, and the newly trained machine-learned model can output a state (price should be increased, decreased, or remain the same), an updated rental or purchase price, or a change to the rental or purchase price.

In some implementations, the machine-learned model also outputs a confidence score. The property system can adjust the price for the property with a particular frequency based on the confidence score. For example, if the confidence score is high, the property system can adjust the price for the property multiple times an hour while if the confidence score is low, the property system can adjust the price for the property once a day or once a week. The property system can also adjust the price for the property by a particular magnitude based on the confidence score. For example, if the confidence score is high, the property system can adjust the price by a higher magnitude than if the confidence score is lower.

Although the description above focuses on rental prices, the techniques described above can also be applied to predict purchase prices for properties.

FIG. 4 is an illustration of an example user interface of a digital listing of a property. A property system can display a public listing for a particular property. The public listing can show an adjusted price 402 to a user engaging with the page. The adjusted price can be generated using the techniques described above. The public listing can also provide user interfaces for scheduling a visit 404 to the property and messaging an owner of the property 406. The property system can track user engagement with each of the user interfaces 404, 406, e.g., the property system tracks the amount of time spent in a page after a user clicks on the button or a number of times the button is clicked. Engaging with the user interface for scheduling a visit 404 will be described below in reference to FIG. 5A. Engaging with the user interface for messaging an owner 406 will be described below in reference to FIG. 5B.

In FIG. 5A, the property system provides a user interface to schedule a visit to rent or purchase a property. The property system can determine, based on a schedule provided by the owner, optimal times 502 for visiting the property. Upon confirming 504, the user interface can display the time selected by the user. Any user engagement on the page can be used for the engagement data to be processed by the machine-learned model described above. In some implementations, the machine-learned model is constantly running in the background, so the user interface can also display a real-time updated price in each interface of the property system, thereby enabling a user to lock in a price and agree to lease the property when the price is acceptable to the user.

In FIG. 5B, the property system provides a user interface to chat with owners of properties using the property system. The user interface can provide a chat box 506 for users to message owners of the property. Each message to and from the owner can serve as engagement data for use in the machine-learned model. Public digital listings where owners respond to many chats from different users will have more engagement data than public digital listings where an owner receives one message from one user.

FIG. 6 is a flow chart of an example process of determining vacancy metrics for properties performed by a property system, e.g., using a vacancy classifier 108 of the the property system 102 referenced in FIG. 1.

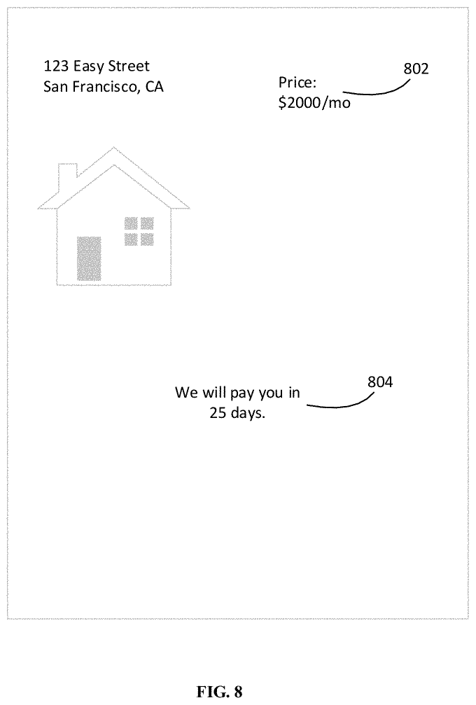

The property system identifies properties based at least on a location (step 602). The location can be received from a user, e.g., through a user interface. The user can be a homeowner that is requesting an offer from the property system by providing a location of the homeowner's property. An example user interface will be described below in reference to FIG. 8.

In some implementations, the property system identifies properties from region to region as part of a recurring process. For example, the property system can, at a predetermined interval, identify all properties inside a certain region and, for each property, apply a machine-learned model to the property, e.g., the vacancy classifier 108 referenced in FIG. 1, to determine a respective vacancy metric.

In some implementations, in addition to location, the property system identifies the properties based on property data, a size of the properties, pricing data, or a timeframe. Property data can include engagement data, impression data, attributes of the property, third-party property data, and other data, as referenced above in FIGS. 1 and 2. In some implementations, the property system creates, for each property, embeddings from one or more subsets of data and identifies properties based on embeddings within a particular threshold.

The property system determines, for each property, a vacancy metric (step 604) using a machine-learned model. The vacancy metric can represent a duration the property will be available for rent. In some implementations, this metric indicates to a user of the property system, e.g., a homeowner, when the user can be paid. In some implementations, the property system automatically pays, using payment information for the user from a user data database (e.g., user data database 116 of FIG. 1), the user a precalculated offer amount for the property after the duration indicated in the vacancy metric subsequent to a completed transaction. In some implementations, the offer amount is an adjusted price for the property from a price classifier 104 of FIG. 1.

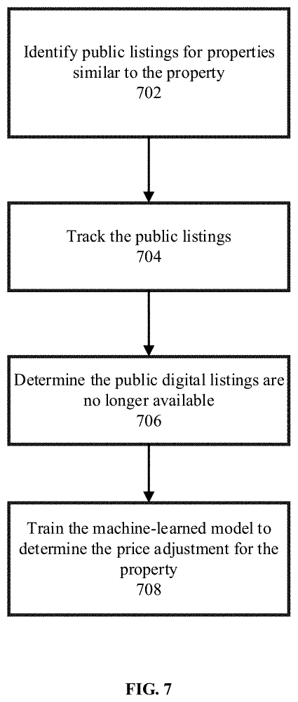

The machine-learning model can be trained using supervised learning algorithms, e.g., linear or logistic regressions, Kalman filters. The machine-learning model can take, as training data, location, availability data, engagement data, impression data, attributes of the property, and other property. The data can be labelled according to the output of the classifier. Further examples of training data and implementations will be described below in reference to FIG. 7.

In some implementations, the output of the machine-learning model is a vacancy metric measured in days. For example, for a particular property, the property system determines, using the model, that the vacancy duration for the property is 24 days. In some other implementations, the vacancy metric includes a duration adjustment for the property. For example, the metric can be +1 day. This metric can be used to adjust a current vacancy duration for the property, e.g., the vacancy duration can be changed from 24 days to 25 days as a result of the vacancy classifier.

The property system sends a user interface comprising the vacancy metric (step 606). This will be described further below in reference to FIG. 8. In some implementations, the property system also uses the vacancy metric to adjust a price for the property. For example, if the vacancy metric is longer than an average of the vacancy metrics in a surrounding area, the property system can lower a predicted price for the property or increase the predicted prices for the surrounding properties. If the vacancy metric is shorter than the average of vacancy metrics in a surrounding area, the property system can increase the predicted price for the property or lower the predicted prices for the surrounding properties. Although an average is used in these examples, other common aggregation methods, e.g., standard deviations, can be used to determine an overall value for the vacancy metrics.

FIG. 7 is a flow chart of an example process of determining vacancy metrics based on tracking public listings.

The property system can identify public digital listings for the property or properties similar to the particular property (step 702). The property system can track the public digital listings (step 704). The property system can determine the public digital listings are no longer available (step 706). Steps 702-706 are similar to steps 302-306 in reference to FIG. 3.

Similar to the system described above in FIG. 3, the property system can aggregate data representing the availability duration, inferred sale, rental prices, or states that are associated with public digital listings and treat the aggregated data as training data for the machine-learned model. In some implementations, the availability duration is considered a label for the vacancy metric. The property system can then train the machine-learned model to determine a vacancy metric for the property (step 708).

In some implementations, the machine-learned model also outputs a confidence score. The property system can adjust the vacancy metric for the property with a particular frequency based on the confidence score. For example, if the confidence score is high, the property system can adjust the vacancy metric for the property multiple times an hour while if the confidence score is low, the property system can adjust the vacancy metric for the property once a day or once a week. The property system can also adjust the vacancy metric for the property by a particular magnitude based on the confidence score. For example, if the confidence score is high, the property system can adjust the vacancy metric by a higher magnitude than if the confidence score is lower.

The techniques described above can also be applied to predict vacancy metrics for rental or purchase properties.

FIG. 8 is an illustration of an example user interface of a digital listing of a property with a vacancy metric. The property system can display a public listing for a particular property. The public listing can show an adjusted price 802 to a user engaging with the page. The adjusted price can be generated using the techniques described above. The public listing can also show a notice to the user indicating a vacancy metric, e.g., a duration 804. In this example, the vacancy metric is based on the amount of time the user can be provided a guarantee, by the property system, for payment. The property system makes this guarantee based on how long the property system can recoup this cost from a prospective renter. The user can be provided with a guaranteed payment, which provides user value, based off of the classifiers running on the property system. This can incentivize the user to choose to have the property system manage a property of the user.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on a non-transitory computer storage medium for execution by, or to control the operation of, data processing apparatus. Alternatively or in addition, the program instructions can be encoded on an artificially generated propagated signal, e.g., a machine generated electrical, optical, or electromagnetic signal, that is generated to encode information for transmission to suitable receiver apparatus for execution by a data processing apparatus. A computer storage medium can be, or be included in, a computer readable storage device, a computer readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a standalone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language resource), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of nonvolatile memory, media and memory devices, including by way of example semiconductor memory devices, e.g., EPROM, EEPROM, and flash memory devices; magnetic disks, e.g., internal hard disks or removable disks; magneto optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending resources to and receiving resources from a device that is used by the user; for example, by sending web pages to a web browser on a user's client device in response to requests received from the web browser.

Embodiments of the subject matter described in this specification can be implemented in a computing system that includes a backend component, e.g., as a data server, or that includes a middleware component, e.g., an application server, or that includes a frontend component, e.g., a client computer having a graphical user interface or a Web browser through which a user can interact with an implementation of the subject matter described in this specification, or any combination of one or more such backend, middleware, or frontend components.

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

Thus, particular embodiments of the subject matter have been described.

What is claimed is:

1. A method comprising, by one or more computing devices:
identifying a plurality of properties based at least on a location;
determining, for each of the plurality of properties using a machine-learned model, a vacancy metric representing a duration the respective property will be available for rent, wherein the machine-learning model is trained using availability data for the plurality of properties;
sending, for display to a user, a user interface comprising the vacancy metric.

2. The method of claim 1, wherein identifying the plurality of properties is further based on one or more of the following: property data comprising a number of bedrooms, a number of bathrooms, or a size, pricing data, or a timeframe.

3. The method of claim 1, further comprising:
receiving a request from a user to generate a vacancy metric for a particular property, wherein the request comprises the location;
in response to receiving the request, determining the vacancy metric is in response to receiving the request, and wherein identifying the plurality of properties is based at least on property data for the property.

4. The method of claim 1, further comprising:
determining a price adjustment for price of the property based on the vacancy metric.

5. The method of claim 1, wherein training the machine-learning model further comprises, for a given property:
identifying public digital listings for the property or properties similar to the property;
tracking the public digital listings, wherein the tracking comprises storing changes in pricing for the public digital listings and availability durations of the public digital listings;
determining one or more public digital listings are no longer available; and
training the machine-learning model to determine the vacancy metric for the property based on determining one or more public digital listings are no longer available.

6. The method of claim 5, further comprising:
determining a confidence score of the machine-learning model; and
adjusting the vacancy metric with a particular frequency based on the confidence score.

7. A system comprising:
a processor; and
computer-readable medium coupled to the processor and having instructions stored thereon, which, when executed by the processor, cause the processor to perform operations comprising:
identifying a plurality of properties based at least on a location;
determining, for each of the plurality of properties using a machine-learned model, a vacancy metric representing a duration the respective property will be available for rent, wherein the machine-learning model is trained using availability data for the plurality of properties;
sending, for display to a user, a user interface comprising the vacancy metric.

8. The system of claim 7, wherein identifying the plurality of properties is further based on one or more of the following: property data comprising a number of bedrooms, a number of bathrooms, or a size, pricing data, or a timeframe.

9. The system of claim 7, further comprising:
receiving a request from a user to generate a vacancy metric for a particular property, wherein the request comprises the location;
in response to receiving the request, determining the vacancy metric is in response to receiving the request, and wherein identifying the plurality of properties is based at least on property data for the property.

10. The system of claim 7, further comprising:
determining a price adjustment for price of the property based on the vacancy metric.

11. The system of claim 7, wherein training the machine-learning model further comprises, for a given property:
identifying public digital listings for the property or properties similar to the property;
tracking the public digital listings, wherein the tracking comprises storing changes in pricing for the public digital listings and availability durations of the public digital listings;
determining one or more public digital listings are no longer available; and
training the machine-learning model to determine the vacancy metric for the property based on determining one or more public digital listings are no longer available.

12. The system of claim 11, further comprising:
determining a confidence score of the machine-learning model; and
adjusting the vacancy metric with a particular frequency based on the confidence score.

13. A computer-readable medium having instructions stored thereon, which, when executed by one or more computers, cause the one or more computers to perform operations for:
identifying a plurality of properties based at least on a location;
determining, for each of the plurality of properties using a machine-learned model, a vacancy metric representing a duration the respective property will be available for rent, wherein the machine-learning model is trained using availability data for the plurality of properties;
sending, for display to a user, a user interface comprising the vacancy metric.

14. The computer-readable medium of claim 13, wherein identifying the plurality of properties is further based on one or more of the following: property data comprising a number of bedrooms, a number of bathrooms, or a size, pricing data, or a timeframe.

15. The computer-readable medium of claim 13, further comprising:
receiving a request from a user to generate a vacancy metric for a particular property, wherein the request comprises the location;
in response to receiving the request, determining the vacancy metric is in response to receiving the request, and wherein identifying the plurality of properties is based at least on property data for the property.

16. The computer-readable medium of claim 13, further comprising:
determining a price adjustment for price of the property based on the vacancy metric.

17. The computer-readable medium of claim 13, wherein training the machine-learning model further comprises, for a given property:
identifying public digital listings for the property or properties similar to the property;
tracking the public digital listings, wherein the tracking comprises storing changes in pricing for the public digital listings and availability durations of the public digital listings;
determining one or more public digital listings are no longer available; and
training the machine-learning model to determine the vacancy metric for the property based on determining one or more public digital listings are no longer available.

18. The computer-readable medium of claim 17, further comprising:
determining a confidence score of the machine-learning model; and
adjusting the vacancy metric with a particular frequency based on the confidence score.
